(19) United States
(12) Patent Application Publication
(10) Pub. No.: US 2026/0012864 A1
(43) Pub. Date: Jan. 8, 2026

(54) WIRELESS AUDIO RECEPTION APPARATUS, WIRELESS AUDIO TRANSMISSION APPARATUS, AND WIRELESS AUDIO OUTPUT SYSTEM COMPRISING SAME

(71) Applicant: LG ELECTRONICS INC., Seoul (KR)

(72) Inventors: Eunjung LIM, Seoul (KR); Suhyun PARK, Seoul (KR)

(73) Assignee: LG ELECTRONICS INC., Seoul (KR)

(21) Appl. No.: 18/994,002

(22) PCT Filed: Jul. 15, 2022
(86) PCT No.: PCT/KR2022/010381

§ 371 Date: Jan. 13, 2025

(51) Int. Cl. H04W 36/06; G06F 3/16; H04R 3/12; H04W 36/28; H04W 36/30; H04W 76/15

(52) U.S. Cl. CPC H04W 36/06; G06F 3/162; G06F 3/165; H04R 3/12; H04W 36/28; H04W 36/305; H04W 76/15; H04R 2420/07

(57) ABSTRACT

A wireless audio receiving device, a wireless audio transmitting device, and a wireless audio output system including the same are disclosed. The wireless audio transmitting device includes a first communication module, a second communication module, and a sound output device, wherein the sound output device is configured to output a first sound, based on the first audio signal from the first communication module, during a first period, output a second sound, based on the audio signal from the first or the second communication module, during a second period, in response to a packet error rate of the first audio signal being equal to or higher than a predetermined value, and output a third sound, based on the audio signal from the second communication module, during a third period. Accordingly, it is possible to seamlessly switch audio service through the first and second communication modules of different communication standards.

### BACKGROUND

### 1. Field

This disclosure relates to a wireless audio receiving device, a wireless audio transmitting device, and a wireless audio output system including the same, and more particularly, to a wireless audio receiving device, a wireless audio transmitting device, and a wireless audio output system including the same capable of stably receiving audio wirelessly and output sound even in complex wireless environments.

### 2. Description of the Related Art

A wireless audio receiving device wirelessly receives an audio signal from an external wireless audio transmitting device, converts the received audio signal into sound, and output it.

U.S. Patent Publication No. US20080310394 (hereinafter, referred to as “prior literature”) discloses a multi-session Bluetooth communication method and system using a multiple physical Phy layer, and discloses that each of a plurality of Bluetooth sessions utilizes a physical PHY layer or MAC layer such as WLAN, and ultra-wideband UWB to transmit or receive data.

However, according to prior literature, there is a disadvantage that it is difficult to distinguish between signal data and audio data in WLAN, ultra-wideband UWB, etc.

Further, according to prior literature, there is a disadvantage in that it is difficult to provide audio service based on a plurality of communication standards and it is difficult to switch the audio service between the plurality of communication standards.

### SUMMARY

The disclosure has been made in view of the above problems, and may provide a wireless audio receiving device, a wireless audio transmitting device, and a wireless audio output system including the same that can seamlessly switch audio service through first and second communication modules of different communication standards.

The disclosure may further provide a wireless audio receiving device, a wireless audio transmitting device, and a wireless audio output system including the same that can stably receive audio wirelessly and output sound even when the wireless environment is complex.

In accordance with an aspect of the present disclosure, a wireless audio receiving device and a wireless audio output system including the same include: a first communication module configured to wirelessly receive a first audio signal based on a first communication standard of a first frequency band, a second communication module configured to wirelessly receive a second audio signal based on a second communication standard of a second frequency band greater than the first frequency band, and a sound output device configured to output a first sound corresponding to the first audio signal from the first communication module or a second sound corresponding to the second audio signal from the second communication module, and the sound output device is configured to output a first sound, based on the first audio signal received from the first communication module, during a first period, and output a second sound, based on the audio signal received from the first communication module or the audio signal received from the second communication module, during a second period after the first period, in response to a packet error rate of the first audio signal being equal to or higher than a predetermined value, and output a third sound, based on the audio signal received from the second communication module, during a third period after the second period.

Meanwhile, the first communication module may be configured to transmit a message switching to the second communication standard to a wireless audio transmitting device, in response to the packet error rate of the first audio signal received from the first communication module being equal to or higher than the predetermined value.

Meanwhile, the first communication module may be configured to transmit a message switching to the second communication standard to a wireless audio transmitting device, in response to the packet error rate of the first audio signal received from the first communication module being equal to or higher than the predetermined value, the second communication module may set a channel based on the second communication standard, after transmitting the message switching to the second communication standard, and the sound output device may be configured to output the second sound, based on the audio signal received from the first communication module or the audio signal received from the second communication module, during the second period.

Meanwhile, the second communication module may be configured to perform channel setting based on a preset channel, in response to setting the channel based on the second communication standard.

Meanwhile, the second communication module may be configured to transmit a channel setup completion message to the wireless audio transmitting device in response to the channel setting being completed.

Meanwhile, during the second period, an encoding method of the audio signal received from the first communication module and an encoding method of the audio signal received from the second communication module may be the same.

Meanwhile, each of the first audio signal and the second audio signal may include a sequence number.

In accordance with an aspect of the present disclosure, a wireless audio receiving device and a wireless audio output system including the same may further include a processor configured to process a signal from the first communication module or the second communication module, and the processor may be configured to determine audio service switching completion time, based on a sequence number in the audio signal received from the first communication module and a sequence number in the audio signal received from the second communication module, during the second period, control to output a sound based on the audio signal received from the first communication module, until the audio service switching completion time during the second period, and control to output a sound based on the audio signal received from the second communication module, from the audio service switching completion time during the second period.

Meanwhile, the second communication module may be configured to transmit an audio service switching completion message to the wireless audio transmitting device, based on the audio service switching completion time.

Meanwhile, the first communication module may be configured to receive an audio signal from the wireless audio transmitting device, during the first period and the second period, and the second communication module may be configured to receive an audio signal from the wireless audio transmitting device, during the second period and the third period.

In accordance with another aspect of the present disclosure, a wireless audio receiving device and a wireless audio output system including the same include: a first communication module configured to wirelessly receive a first audio signal based on a first communication standard of a first frequency band, a second communication module configured to wirelessly receive a second audio signal based on a second communication standard of a second frequency band greater than the first frequency band, and a sound output device configured to output a first sound corresponding to the first audio signal from the first communication module or a second sound corresponding to the second audio signal from the second communication module, and the second communication module may be configured to transmit a message switching to the second communication standard to a wireless audio transmitting device, in response to a packet error rate of the first audio signal received from the first communication module being equal to or higher than a predetermined value.

Meanwhile, the sound output device may be configured to output a first sound corresponding to the first audio signal from the first communication module, in response to the packet error rate of the first audio signal received from the first communication module being less than the predetermined value, and output a sound corresponding to the audio signal received from the first communication module or the second communication module, in response to the packet error rate of the first audio signal received from the first communication module being equal to or higher than the predetermined value, and output a second sound corresponding to a second audio signal from the second communication module, after the audio service switching is completed.

In accordance with an aspect of the present disclosure, a wireless audio transmitting device and a wireless audio output system including the same include: a first communication module configured to wirelessly transmit a first audio signal based on a first communication standard of a first frequency band, a second communication module configured to wirelessly transmit a second audio signal based on a second communication standard of a second frequency band greater than the first frequency band, and a processor configured to control the first communication module and the second communication module, and the processor may be configured to control the first communication module to transmit the first audio signal during a first period, and control the first communication module and the second communication module to transmit the audio signal, during a second period after the first period, in response to receiving a switching message from the wireless audio receiving device.

Meanwhile, the processor may be configured to control the second communication module to transmit the audio signal during a third period after the second period, in response to receiving an audio service switching completion message from the wireless audio receiving device.

### EFFECTS OF THE DISCLOSURE

A wireless audio receiving device and a wireless audio output system including the same according to an embodiment of the present disclosure include: a first communication module configured to wirelessly receive a first audio signal based on a first communication standard of a first frequency band, a second communication module configured to wirelessly receive a second audio signal based on a second communication standard of a second frequency band greater than the first frequency band, and a sound output device configured to output a first sound corresponding to the first audio signal from the first communication module or a second sound corresponding to the second audio signal from the second communication module, and the sound output device is configured to output a first sound, based on the first audio signal received from the first communication module, during a first period, and output a second sound, based on the audio signal received from the first communication module or the audio signal received from the second communication module, during a second period after the first period, in response to a packet error rate of the first audio signal being equal to or higher than a predetermined value, and output a third sound, based on the audio signal received from the second communication module, during a third period after the second period. Accordingly, it is possible to seamlessly switch audio service through the first and second communication modules of different communication standards. Furthermore, it is possible to stably receive audio wirelessly and output sound even in complex wireless environments.

Meanwhile, the first communication module may be configured to transmit a message switching to the second communication standard to a wireless audio transmitting device, in response to the packet error rate of the first audio signal received from the first communication module being equal to or higher than the predetermined value. Accordingly, it is possible to seamlessly switch audio service.

Meanwhile, the first communication module may be configured to transmit a message switching to the second communication standard to a wireless audio transmitting device, in response to the packet error rate of the first audio signal received from the first communication module being equal to or higher than the predetermined value, the second communication module may set a channel based on the second communication standard, after transmitting the message switching to the second communication standard, and the sound output device may be configured to output the second sound, based on the audio signal received from the first communication module or the audio signal received from the second communication module, during the second period. Accordingly, it is possible to seamlessly switch audio service.

Meanwhile, the second communication module may be configured to perform channel setting based on a preset channel, in response to setting the channel based on the second communication standard. Accordingly, it is possible to rapidly set a channel.

Meanwhile, the second communication module may be configured to transmit a channel setup completion message to the wireless audio transmitting device in response to the channel setting being completed. Accordingly, it is possible to rapidly perform a procedure after a channel has been set.

Meanwhile, during the second period, an encoding method of the audio signal received from the first communication module and an encoding method of the audio signal received from the second communication module may be the same. Accordingly, it is possible to rapidly switch audio service.

Meanwhile, each of the first audio signal and the second audio signal may include a sequence number. Accordingly, it is possible to seamlessly switch audio service.

In accordance with an aspect of the present disclosure, a wireless audio receiving device and a wireless audio output system including the same may further include a processor configured to process a signal from the first communication module or the second communication module, and the processor may be configured to determine audio service switching completion time, based on a sequence number in the audio signal received from the first communication module and a sequence number in the audio signal received from the second communication module, during the second period, control to output a sound based on the audio signal received from the first communication module, until the audio service switching completion time during the second period, and control to output a sound based on the audio signal received from the second communication module, from the audio service switching completion time during the second period. Accordingly, it is possible to seamlessly switch audio service.

Meanwhile, the second communication module may be configured to transmit an audio service switching completion message to the wireless audio transmitting device, based on the audio service switching completion time. Accordingly, it is possible to stop receiving an audio signal according to a first communication standard from a wireless audio transmitting device.

Meanwhile, the first communication module may be configured to receive an audio signal from the wireless audio transmitting device, during the first period and the second period, and the second communication module may be configured to receive an audio signal from the wireless audio transmitting device, during the second period and the third period. Accordingly, it is possible to seamlessly switch audio service.

In accordance with another aspect of the present disclosure, a wireless audio receiving device and a wireless audio output system including the same include: a first communication module configured to wirelessly receive a first audio signal based on a first communication standard of a first frequency band, a second communication module configured to wirelessly receive a second audio signal based on a second communication standard of a second frequency band greater than the first frequency band, and a sound output device configured to output a first sound corresponding to the first audio signal from the first communication module or a second sound corresponding to the second audio signal from the second communication module, and the second communication module may be configured to transmit a message switching to the second communication standard to a wireless audio transmitting device, in response to a packet error rate of the first audio signal received from the first communication module being equal to or higher than a predetermined value. Accordingly, it is possible to seamlessly switch audio service through the first and second communication modules of different communication standards.

Meanwhile, the sound output device may be configured to output a first sound corresponding to the first audio signal from the first communication module, in response to the packet error rate of the first audio signal received from the first communication module being less than the predetermined value, and output a sound corresponding to the audio signal received from the first communication module or the second communication module, in response to the packet error rate of the first audio signal received from the first communication module being equal to or higher than the predetermined value, and output a second sound corresponding to a second audio signal from the second communication module, after the audio service switching is completed. Accordingly, it is possible to seamlessly switch audio service through the first and second communication modules of different communication standards.

In accordance with an aspect of the present disclosure, a wireless audio transmitting device and a wireless audio output system including the same include: a first communication module configured to wirelessly transmit a first audio signal based on a first communication standard of a first frequency band, a second communication module configured to wirelessly transmit a second audio signal based on a second communication standard of a second frequency band greater than the first frequency band, and a processor configured to control the first communication module and the second communication module, and the processor may be configured to control the first communication module to transmit the first audio signal during a first period, and control the first communication module and the second communication module to transmit the audio signal, during a second period after the first period, in response to receiving a switching message from the wireless audio receiving device. Accordingly, it is possible to seamlessly switch audio service through the first and second communication modules of different communication standards.

Meanwhile, the processor may be configured to control the second communication module to transmit the audio signal during a third period after the second period, in response to receiving an audio service switching completion message from the wireless audio receiving device. Accordingly, it is possible to stop transmitting an audio signal according to a first communication standard to a wireless audio receiving device.

### BRIEF DESCRIPTION OF THE DRAWINGS

FIGS. 1A to 1E are diagrams illustrating a wireless audio output system including a wireless audio receiving device and a wireless audio transmitting device according to various embodiments of the present disclosure;

FIG. 2 is an example of an internal block diagram of the wireless audio receiving device of FIGS. 1A to 1E;

FIGS. 3A to 8B are diagrams for explaining an operation of a wireless audio receiving device or a wireless audio transmitting device according to an embodiment of the present disclosure;

FIG. 9 is an example of a flowchart showing a method of operating a wireless audio output system according to an embodiment of the present disclosure; and

FIGS. 10 to 15B are diagrams for explaining FIG. 9.

### DETAILED DESCRIPTION OF THE PREFERRED EMBODIMENTS

Hereinafter, the present disclosure will be described in more detail with reference to the drawings.

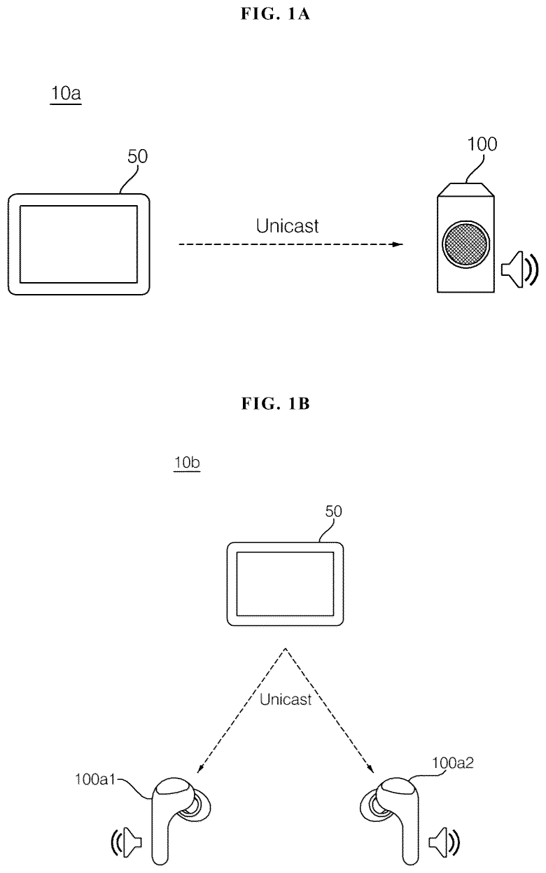

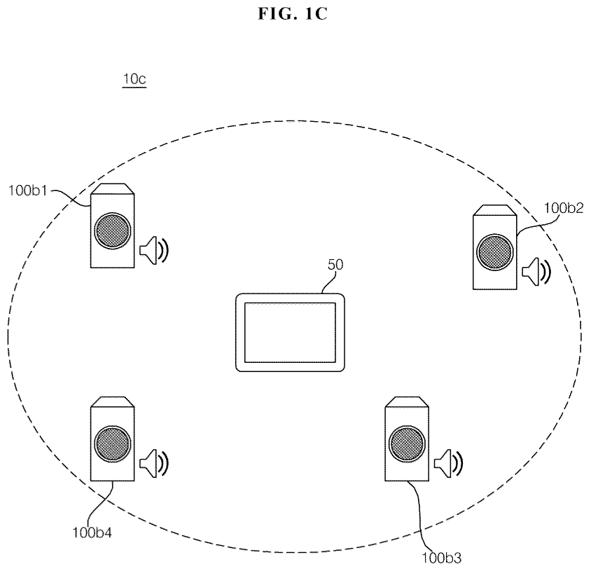

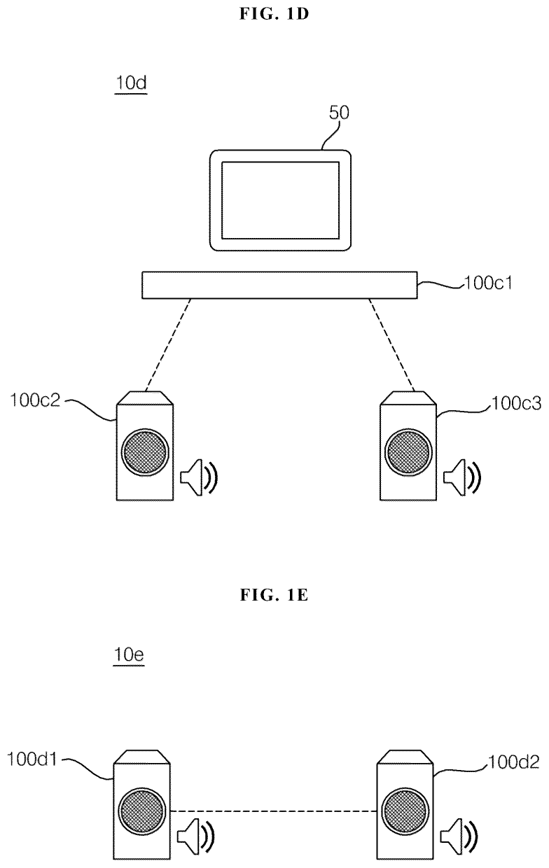

The suffixes such as “module” and “unit” may be used to refer to elements or components. Use of such suffixes herein is merely intended to facilitate description of the specification, and the suffixes do not have any special meaning or function. Accordingly, the “module” and “unit” may be used interchangeably. FIGS. 1A to 1E are diagrams illustrating a wireless audio output system including a wireless audio receiving device and a wireless audio transmitting device according to various embodiments of the present disclosure.

First, FIG. 1A illustrates a wireless audio output system 10a according to an embodiment of the present disclosure.

Referring to FIG. 1A, the wireless audio output system 10a according to an embodiment of the present disclosure may include a wireless audio transmitting device 50 and a wireless audio receiving device 100.

In particular, in the wireless audio output system 10a, the wireless audio transmitting device 50 and the wireless audio receiving device 100 may correspond one-to-one, based on a unicast method.

The wireless audio transmitting device 50 may include a first communication module 135a wirelessly transmitting a first audio signal based on a first communication standard of a first frequency band, and a second communication module 135b wirelessly transmitting a second audio signal based on a second communication standard of a second frequency band greater than the first frequency band.

Meanwhile, the wireless audio receiving device 100 may include a first communication module 135a wirelessly receiving a first audio signal according to the first communication standard of a first frequency band, and a second communication module 135b wirelessly receiving a second audio signal according to the second communication standard of a second frequency band greater than the first frequency band.

For example, when the wireless audio receiving device 100 outputs the first sound wirelessly based on the first audio signal according to the first communication standard of the first frequency band received from the first communication module 135a and then the packet error rate of the first audio signal is equal to or higher than a predetermined value in complex wireless environments, the device may be configured to output the second sound wirelessly based on the second audio signal according to the second communication standard of the second frequency band received from the second communication module 135b.

Accordingly, even in complex wireless environments, it is possible to stably receive audio wirelessly and output sound.

Meanwhile, the wireless audio receiving device 100 may be configured to output the first sound based on the first audio signal according to the first communication standard and then output the second sound based on the second audio signal according to the second communication standard. During a certain period before outputting, the first communication module 135a and the second communication module 135b may simultaneously receive the audio signals and output sound based on one of the audio signals. Thus, it is possible to seamlessly switch the audio service.

At this time, the wireless audio transmitting device 50 may be a mobile terminal such as a mobile phone or tablet.

Next, FIG. 1B illustrates a wireless audio output system 10b according to another embodiment of the present disclosure.

Referring to FIG. 1B, the wireless audio output system 10b according to another embodiment of the present disclosure may include a wireless audio transmitting device 50 and a plurality of wireless audio receiving devices 100a1 and 100a2.

In particular, the wireless audio output system 10b may include a wireless audio transmitting device 50 and a plurality of wireless audio receiving devices 100a1 and 100a2, based on a unicast method.

For example, when wireless audio signals of a first channel to a second channel are output from the wireless audio transmitting device 50, a wireless audio signal of the first channel may be transmitted to a first wireless audio receiving device 100a1 among a plurality of wireless audio receiving devices 100a1 and 100a2, and a wireless audio signal of the second channel may be transmitted to a second wireless audio receiving device 100a2. Accordingly, it is possible to stably receive audio wirelessly and output sound even in complex wireless environments.

Meanwhile, when each of the wireless audio receiving devices 100a1 to 100a2 outputs the first sound wirelessly based on the first audio signal according to the first communication standard of the first frequency band received from the first communication module 135a and then the packet error rate of the first audio signal is equal to or higher than a predetermined value in complex wireless environments, the device may be configured to output the second sound wirelessly based on the second audio signal according to the second communication standard of the second frequency band received from the second communication module 135b. Accordingly, it is possible to stably receive audio wirelessly and output sound even in complex wireless environments.

Meanwhile, each of the wireless audio receiving devices 100a1 to 100a2 outputs the first sound based on the first audio signal according to the first communication standard and then output the second sound based on the second audio signal according to the second communication standard. During a certain period before outputting, the first communication module 135a and the second communication module 135b may simultaneously receive the audio signals and output sound based on one of the audio signals. Thus, it is possible to seamlessly switch the audio service.

At this time, the plurality of wireless audio receiving devices 100a1 and 100a2 may be left and right wireless audio receiving devices, respectively.

Next, FIG. 1C illustrates a wireless audio output system 10c according to another embodiment of the present disclosure.

Referring to FIG. 1C, a wireless audio output system 10c according to another embodiment of the present disclosure may include a wireless audio transmitting device 50 and a plurality of wireless audio receiving devices 100b1 to 100b4.

In particular, the wireless audio output system 10c may include a wireless audio transmitting device 50 and a plurality of wireless audio receiving devices 100b 1 to 100b4, based on a broadcast method.

For example, when wireless audio signals of first to fourth channels are output from the wireless audio transmitting device 50, a wireless audio signal of a first channel may be transmitted to a first wireless audio receiving device 100b1 among a plurality of wireless audio receiving devices 100b1 to 100b4, a wireless audio signal of a second channel may be transmitted to a second wireless audio receiving device 100b2, a wireless audio signal of a third channel may be transmitted to a third wireless audio receiving device 100b3, and a wireless audio signal of a fourth channel may be transmitted to a fourth wireless audio receiving device 100b4. Accordingly, it is possible to stably receive audio wirelessly and output sound even in complex wireless environments.

Meanwhile, when each of the wireless audio receiving devices 100b1 to 100b4 outputs the first sound wirelessly based on the first audio signal according to the first communication standard of the first frequency band received from the first communication module 135a and then the packet error rate of the first audio signal is equal to or higher than a predetermined value in complex wireless environments, the device may be configured to output the second sound wirelessly based on the second audio signal according to the second communication standard of the second frequency band received from the second communication module 135b. Accordingly, it is possible to stably receive audio wirelessly and output sound even in complex wireless environments.

Meanwhile, each of the wireless audio receiving devices 100b1 to 100b4 outputs the first sound based on the first audio signal according to the first communication standard and then output the second sound based on the second audio signal according to the second communication standard. During a certain period before outputting, the first communication module 135a and the second communication module 135b may simultaneously receive the audio signals and output sound based on one of the audio signals. Thus, it is possible to seamlessly switch the audio service.

Next, FIG. 1D illustrates a wireless audio output system 10d according to another embodiment of the present disclosure.

Referring to FIG. 1D, the wireless audio output system 10d according to another embodiment of the present disclosure may include a wireless audio transmitting device 50 and a plurality of wireless audio receiving devices 100c1 to 100c3.

In particular, the wireless audio output system 10d may include a wireless audio transmitting device 50 and a plurality of wireless audio receiving devices 100c1 to 100c3, based on a unicast method.

For example, when wireless audio signals of first to third channels are output from the wireless audio transmitting device 50, a wireless audio signal of a first channel may be transmitted to a first wireless audio receiving device 100c1 among a plurality of wireless audio receiving devices 100c1 to 100c3, a wireless audio signal of a second channel may be transmitted to a second wireless audio receiving device 100c2, and a wireless audio signal of a third channel may be transmitted to a third wireless audio receiving device 100c3.

As another example, when wireless audio signals of first to third channels are output from the wireless audio transmitting device 50, wireless audio signals of a first channel to a third channel may be transmitted to a first wireless audio receiving device 100c1 among a plurality of wireless audio receiving devices 100c1 to 100c3, the first wireless audio receiving device 100c1 may be configured to output wireless audio signals of second to third channels, a wireless audio signal of the second channel may be transmitted to a second wireless audio receiving device 100c2, and a wireless audio signal of the third channel may be transmitted to a third wireless audio receiving device 100c3.

Accordingly, even though the wireless environment is complicated, it is possible to stably receive audio wirelessly and output sound.

Meanwhile, when each of the wireless audio receiving devices 100c1 to 100c3 outputs the first sound wirelessly based on the first audio signal according to the first communication standard of the first frequency band received from the first communication module 135a and then the packet error rate of the first audio signal is equal to or higher than a predetermined value in complex wireless environments, the device may be configured to output the second sound wirelessly based on the second audio signal according to the second communication standard of the second frequency band received from the second communication module 135b. Accordingly, it is possible to stably receive audio wirelessly and output sound even in complex wireless environments.

Meanwhile, each of the wireless audio receiving devices 100c1 to 100c3 outputs the first sound based on the first audio signal according to the first communication standard and then output the second sound based on the second audio signal according to the second communication standard. During a certain period before outputting, the first communication module 135a and the second communication module 135b may simultaneously receive the audio signals and output sound based on one of the audio signals. Thus, it is possible to seamlessly switch the audio service.

Next, FIG. 1E illustrates a wireless audio output system 10e according to another embodiment of the present disclosure.

Referring to FIG. 1E, a wireless audio output system 10e according to another embodiment of the present disclosure may include a plurality of wireless audio receiving devices 100d1 and 100d2.

In particular, the wireless audio output system 10e may include a plurality of wireless audio receiving devices 100d1 and 100d2, based on a unicast method.

For example, when a wireless audio signal is output from the first wireless audio receiving device 100d1, the wireless audio signal may be transmitted to the second wireless audio receiving device 100d2.

Accordingly, even though the wireless environment is complicated, it is possible to stably receive audio wirelessly and output sound.

Meanwhile, when each of the wireless audio receiving devices 100d1 to 100d2 outputs the first sound wirelessly based on the first audio signal according to the first communication standard of the first frequency band received from the first communication module 135a and then the packet error rate of the first audio signal is equal to or higher than a predetermined value in complex wireless environments, the device may be configured to output the second sound wirelessly based on the second audio signal according to the second communication standard of the second frequency band received from the second communication module 135b. Accordingly, it is possible to stably receive audio wirelessly and output sound even in complex wireless environments.

Meanwhile, each of the wireless audio receiving devices 100d1 and 100d2 outputs the first sound based on the first audio signal according to the first communication standard and then output the second sound based on the second audio signal according to the second communication standard. During a certain period before outputting, the first communication module 135a and the second communication module 135b may simultaneously receive the audio signals and output sound based on one of the audio signals. Thus, it is possible to seamlessly switch the audio service.

Meanwhile, the wireless audio transmitting device 50 illustrated in FIGS. 1A to 1E may be a mobile terminal, a TV, a monitor, a tablet, a home appliance, a vehicle display device, and the like.

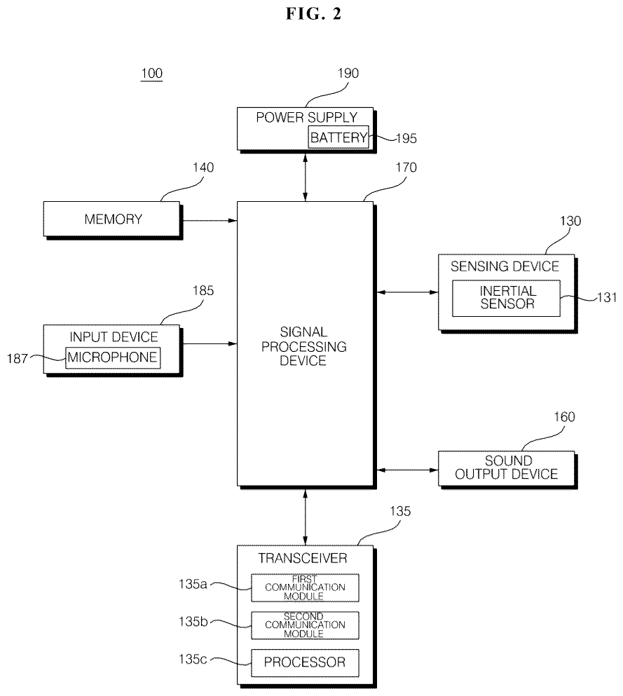

FIG. 2 is an example of an internal block diagram of the wireless audio receiving device of FIGS. 1A to 1E.

Referring to FIG. 2, the wireless audio receiving device 100 may include a sensing device 130, a transceiver 135, a memory 140, a sound output device 160, a processor 170, an input device 185, and a power supply 190. When these components are implemented in actual applications, if necessary, two or more components may be combined into one component, or one component may be subdivided into two or more components.

The sensing device 130 may include an inertial sensor 131. The inertial sensor may include an acceleration sensor, a gyro sensor, a gravity sensor, or the like. For example, the acceleration sensor, the gyro sensor, the gravity sensor, or the like may include a 6-axis sensor.

The sensing device 130 may be configured to output motion information of the wireless audio receiving device 100, for example, movement information (acceleration information, angular velocity information) or location information based on x, y, z axis.

Meanwhile, the sensing device 130 may include a sensor for obtaining user body information. For example, a blood pressure sensor, a brain wave sensor, or the like may be provided.

Meanwhile, the transceiver 135 may provide an interface for communication with an external device. To this end, the transceiver 135 may include at least one of a mobile communication module (not shown), a wireless Internet module (not shown), a short-distance communication module (not shown), or a GPS module (not shown).

For example, the transceiver 135 may be configured to perform IR communication, Bluetooth communication, or WiFi communication, thereby exchanging data with a paired wireless audio transmitting device 50 or transmitting data. In particular, it may be configured to receive an audio signal from the paired wireless audio transmitting device 50.

Meanwhile, the transceiver 135 may include a first communication module 135a that wirelessly receives a first audio signal according to the first communication standard of a first frequency band, and a second communication module 135b that wirelessly receives a second audio signal according to the second communication standard of a second frequency band greater than the first frequency band.

Meanwhile, the transceiver 135 may further include a signal processing device 135c for signal processing or control of the first communication module 135a and the second communication module 135b.

Meanwhile, the first communication module 135a receives a first signal data through a first channel CH1, and separately receives a first audio data through a second channel CH2, and the second communication module 135b separately receives a second signal data and a second audio data through the same channel CHm.

Accordingly, even though the wireless environment is complicated, it is possible to stably receive audio wirelessly and output sound. In addition, signal data and audio data can be distinguished in the first communication module 135a and the second communication module 135b, so that audio can be stably received wirelessly and sound can be output.

Meanwhile, the beacon message received by the second communication module 135b may include unicast information or broadcast information. Accordingly, it is possible to operate by dividing into unicast and broadcast.

Meanwhile, in response to unicast information being included in the received beacon message, the second communication module 135b may be configured to transmit association request information to the wireless audio transmitting device 50 or 100, and may be configured to receive association response information from the wireless audio transmitting device 50 or 100. Accordingly, it is possible to operate by dividing into unicast and broadcast.

Meanwhile, the second communication module 135b may distinguish whether it is the second signal data or the second audio data, based on identification information in the header among the received second audio signal. Accordingly, signal data and audio data can be distinguished, thereby stably receiving audio wirelessly and outputting sound.

Meanwhile, the second communication module 135b may distinguish whether it is the second signal data or the second audio data, based on identification information in a media access control (MAC) header or a physical (PHY) header among the received second audio signal. Accordingly, signal data and audio data can be distinguished, thereby stably receiving audio wirelessly and outputting sound.

Meanwhile, in response to receiving the second signal data, the second communication module 135b may extract encoding or decoding information of the second standard, and based on the extracted encoding or decoding information, may be configured to receive the second audio data after the second signal data, and may set a replay time of the second audio data. Accordingly, signal data and audio data can be distinguished, thereby stably receiving audio wirelessly and outputting sound.

The memory 140 may store programs for processing or controlling the processor 170 in the wireless audio receiving device 100, or may be configured to perform a function for temporarily storing input or output data.

The sound output device 160 may be configured to output an audio signal processed by the processor 170 in the wireless audio receiving device 100.

Alternatively, the sound output device 160 may be configured to output guide information related to the operation of the wireless audio receiving device 100 as an audio signal.

Meanwhile, the sound output device 160 may be configured to output a first sound corresponding to the first audio signal from the first communication module 135a or a second sound corresponding to the second audio signal from the second communication module 135b.

The processor 170 may control the overall operation of the wireless audio receiving device 100 by controlling the operation of each unit in the wireless audio receiving device 100.

Meanwhile, the processor 170 may be configured to perform signal processing for an audio signal received from the outside.

Meanwhile, the processor 170 may replay an audio signal from the first communication module 135a or the second communication module 135b.

Meanwhile, the processor 170 may replay the second audio data, based on the decoding information from the second communication module 135b and a set replay time. Accordingly, signal data and audio data can be distinguished, thereby stably receiving audio wirelessly and outputting sound.

Meanwhile, the input device 185 may include a button for initializing the wireless audio receiving device 100, or inputting an operation.

Meanwhile, the input device 185 may include a microphone 187 for sound collection.

Meanwhile, the input device 185 may include a camera (not shown) for capturing images.

For example, as shown in FIG. 2, the input device 185 may include, in the drawing, a power key 185a for turning power on or off, a FF/REW key 185b for going forward or backward in the reproducing audio, a volume key 185c for volume up or down, a pause/play key 185d for playing or pausing audio, and the like.

The power supply 190 may supply power required for operation of each component under the control of the processor 170.

In particular, the power supply 190 may include a battery 195 that stores and output DC power.

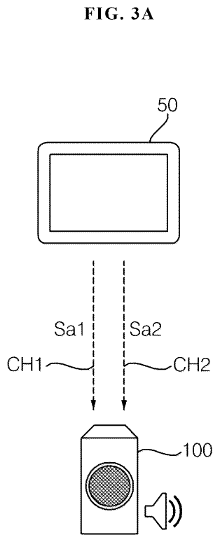

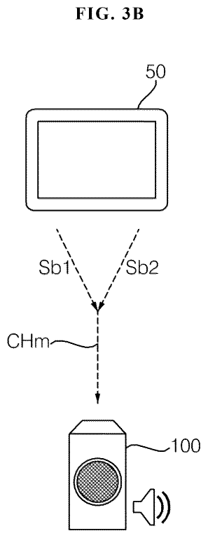

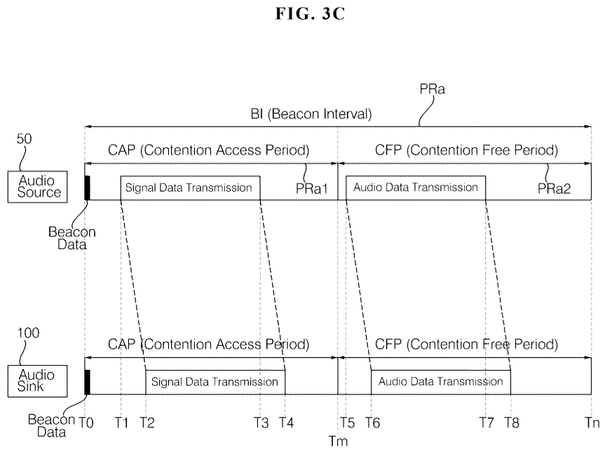

FIGS. 3A to 8B are diagrams for explaining an operation of a wireless audio receiving device or a wireless audio transmitting device according to an embodiment of the present disclosure.

FIG. 3A illustrates that the wireless audio transmitting device 50 outputs a first signal data Sa1 and a first audio data Sa2 to the wireless audio receiving device 100.

Referring to FIG. 3A, the wireless audio transmitting device 50 wirelessly outputs the first signal data Sa1 and the first audio data Sa2 according to the first communication standard of a first frequency band.

In particular, the wireless audio transmitting device 50 may be configured to transmit the first signal data Sa1 through the first channel CH1, and separately transmit the first audio data Sa2 through the second channel CH2.

Accordingly, the first communication module 135a in the wireless audio receiving device 100 according to an embodiment of the present disclosure receives the first signal data Sa1 through the first channel CH1, and distinguishes and receives the first audio data Sa2 through the second channel CH2.

FIG. 3B illustrates that the wireless audio transmitting device 50 outputs the second signal data Sb1 and the second audio data Sb2 to the wireless audio receiving device 100.

Referring to FIG. 3B, the wireless audio transmitting device 50 wirelessly outputs the second signal data Sb1 and the second audio data Sb2 according to the second communication standard of a second frequency band greater than the first frequency band.

In particular, the wireless audio transmitting device 50 may separately transmit the second signal data Sb1 and the second audio data Sb2 through the same channel CHm.

Accordingly, the second communication module 135b in the wireless audio receiving device 100 according to an embodiment of the present disclosure separately receives the second signal data Sb1 and the second audio data Sb2 through the same channel CHm.

Meanwhile, the first communication standard may be a Bluetooth communication standard, and the second communication standard may be an ultra-wideband (UWB) communication standard.

For example, the wireless audio transmitting device 50 may wirelessly transmit an audio signal according to the first communication standard, and then wirelessly transmit the audio signal according to the second communication standard when the wireless environment is complicated.

Accordingly, the wireless audio receiving device 100 may stably receive audio wirelessly and output sound even though the wireless environment is complicated. In addition, signal data and audio data can be distinguished in the first communication module 135a and the second communication module 135b, so that audio can be stably received wirelessly and sound can be output.

Meanwhile, the first communication module 135a according to an embodiment of the present disclosure may be configured to transmit the first signal data Sa1 through the first channel CH1, and may be configured to transmit the first audio data Sa2 separately through the second channel CH2. The second communication module 135b may be configured to transmit the second signal data Sb1 and the second audio data Sb2 separately through the same channel CHm. Accordingly, it is possible to stably transmit audio wirelessly even in complex wireless environments. In addition, the signal data and the audio data can be separately transmitted.

Meanwhile, the beacon message transmitted from the second communication module 135b in the wireless audio transmitting device 50 may include unicast information or broadcast information. Accordingly, it is possible to operate by dividing into unicast and broadcast.

Meanwhile, in response to unicast information being included in the transmitted beacon message, the second communication module 135b in the wireless audio transmitting device 50 may be configured to receive association request information from the wireless audio receiving device 100, and may be configured to transmit association response information from an electronic device to the wireless audio receiving device 100. Accordingly, it is possible to operate by dividing into unicast and broadcast. Further, it will check if ultra-wideband (UWB) wireless audio support is available, allowing audio data to be transmitted wirelessly.

Meanwhile, the second communication module 135b in the wireless audio transmitting device 50 may add identification information in a media access control (MAC) header or a physical (PHY) header in order to distinguish whether the transmitted second audio signal is the second signal data Sb1 or the second audio data Sb2. Accordingly, it is possible to operate by dividing into unicast and broadcast.

Meanwhile, when the first communication module 135a in the wireless audio transmitting device 50 transmits the first audio signal and then the second communication module 135b transmits the second audio signal, Host Control Interface (HCI) data of the first communication standard may be mapped to MAC Layer Management Entity (MLME) interface of the second communication standard, and Asynchronous Connection-Less (ACL) data and audio data of the first communication standard may be mapped to a MAC Common Part Sublayer (MCPS) interface of the second communication standard. Accordingly, signal data and audio data can be distinguished, thereby stably transmitting audio wirelessly.

Meanwhile, when the first communication module 135a in the wireless audio transmitting device 50 transmits the first audio signal and then the second communication module 135b transmits the second audio signal, an adaptation layer (AL) may be used to map data of the first communication standard to data of the second communication standard. Accordingly, signal data and audio data can be distinguished, thereby stably transmitting audio wirelessly.

Meanwhile, when the second communication module 135b in the wireless audio transmitting device 50 transmits the second audio signal, it may be configured to transmit the second signal data Sb1 in a contention access period (CAP) of the beacon interval PRa, and may be configured to transmit the second audio data Sb2 in a contention free period (CFP) of the beacon interval PRa. Accordingly, signal data and audio data can be distinguished, thereby stably transmitting audio wirelessly.

Meanwhile, the first communication module 135a in the wireless audio transmitting device 50 may be configured to transmit the first signal data Sa1 and transmit identification information in the first signal data Sa1 to the second communication module 135b, and the second communication module 135b may separately transmit the second signal data Sb1 in the second audio signal, based on the identification information from the first communication module 135a. Accordingly, signal data and audio data can be distinguished, thereby stably transmitting audio wirelessly.

Meanwhile, the first communication module 135a in the wireless audio transmitting device 50 may be configured to transmit the first audio data Sa2 and transmit identification information in the first audio data Sa2 to the second communication module 135b, and the second communication module 135b may separately transmit the second audio data Sb2 in the second audio signal, based on the identification information from the first communication module 135a. Accordingly, signal data and audio data can be distinguished, thereby stably transmitting audio wirelessly.

Meanwhile, the second communication module 135b in the wireless audio transmitting device 50 may be configured to receive a security activation value from the wireless audio receiving device 100, and if it matches, generate a key, and encrypt and transmit the second audio data Sb2 by using the generated key. Accordingly, it is possible to stably transmit audio wirelessly based on security.

FIG. 3C is a diagram for explaining the operation of the wireless audio transmitting device 50 and the first communication module 135a of the wireless audio receiving device 100.

Referring to FIG. 3, the wireless audio transmitting device 50 may wirelessly transmit beacon data at time To during the beacon interval PRa, and the wireless audio receiving device 100 may wirelessly receive the beacon data.

Meanwhile, the wireless audio transmitting device 50 may be configured to transmit signal data in a contention access period (CAP) of the beacon interval PRa, and transmit audio data in a contention free period (CFP) of the beacon interval PRa.

In particular, FIG. 3 illustrates that signal data is transmitted between time T1 and time T3 within a contention access period (CAP), and audio data is transmitted between time T5 and time T7 within a contention free period (CFP).

In response, the wireless audio receiving device 100 may be configured to receive signal data between time T2 and time T4 within a contention access period (CAP), and may be configured to receive audio data between time T6 and time T8 within a contention free period (CFP).

That is, when the second communication module 135b in the wireless audio receiving device 100 receives the second audio signal, it may be configured to receive the second signal data Sb1 in the contention access period (CAP) of the beacon interval PRa, and may be configured to receive the second audio data Sb2 in the contention free period (CFP) of the beacon interval PRa. Accordingly, signal data and audio data can be distinguished, thereby stably receiving audio wirelessly and outputting sound.

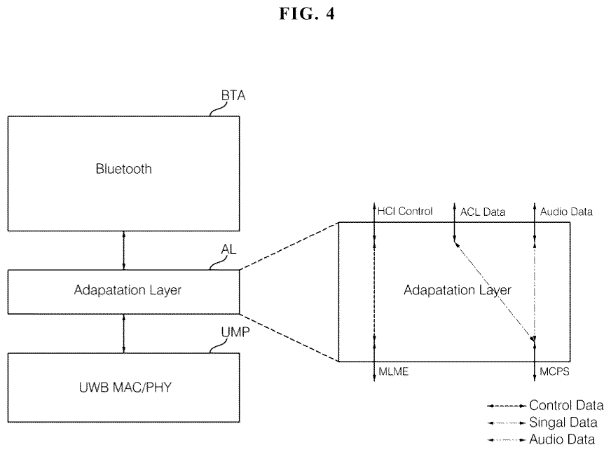

FIG. 4 is a diagram for explaining mapping between the first communication standard and the second communication standard.

Referring to FIG. 4, in order to provide a UWB audio service which is an example of the second communication standard, Bluetooth audio, which is an example of the first communication standard optimized for the audio service, is adopted as an upper protocol.

Bluetooth audio (BTA) interface is composed of HCI Control, ACL Data, and Audio Data.

Meanwhile, the Media access control or physical layer (MAC/PHY) (UMP) of UWB may have a MAC Layer Management Entity (MLME) interface and a MAC Common Part Sublayer (MCPS) interface.

Meanwhile, for mapping between Bluetooth audio (BTA) and UWB media access control or a physical layer (MAC/PHY) (UMP), an adaptation layer (AL) is utilized in an embodiment of the present disclosure.

In the adaptation layer (AL), Host Control Interface (HCI) data of the first communication standard may be mapped to MAC Layer Management Entity (MLME) interface of the second communication standard, and Asynchronous Connection-Less (ACL) data and audio data of the first communication standard may be mapped to a MAC Common Part Sublayer (MCPS) interface of the second communication standard.

Meanwhile, UWB wireless transmission or UWB wireless reception has a frequency band 3.1 GHz to 10.6 GHz different from the unlicensed band 2.4 GHz, thereby avoiding frequency interference with other wireless devices using the unlicensed band, and solving problems such as audio interruption.

In addition, since UWB wireless transmission or UWB wireless reception provides a higher PHY data rate than Bluetooth wireless transmission or wireless reception, high-quality audio service is possible.

Meanwhile, when the first communication module 135a receives the first audio signal and then the second communication module 135b receives the second audio signal, Host Control Interface (HCI) data of the first communication standard may be mapped to the MAC Layer Management Entity (MLME) interface of the second communication standard, and Asynchronous Connection-Less (ACL) data and audio data of the first communication standard may be mapped to the MAC Common Part Sublayer (MCPS) interface of the second communication standard. Accordingly, signal data and audio data can be distinguished, thereby stably receiving audio wirelessly and outputting sound.

Meanwhile, when the first communication module 135a receives the first audio signal and then the second communication module 135b receives the second audio signal, data of the first communication standard may be mapped to data of the second communication standard by using an adaptation layer AL. Accordingly, signal data and audio data can be distinguished, thereby stably receiving audio wirelessly and outputting sound.

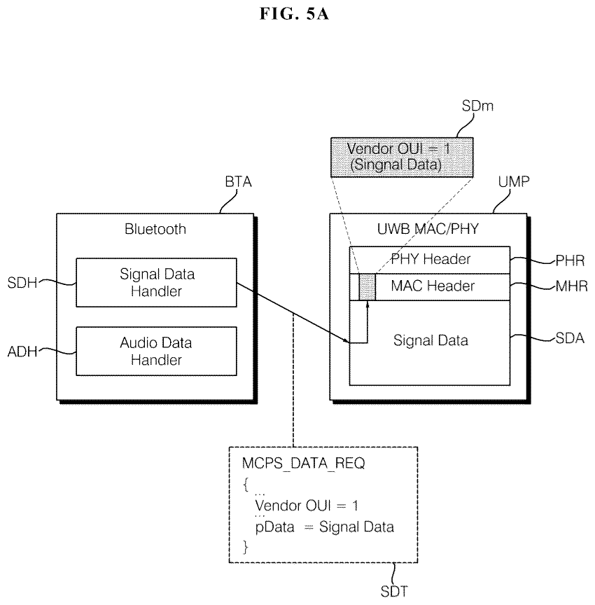

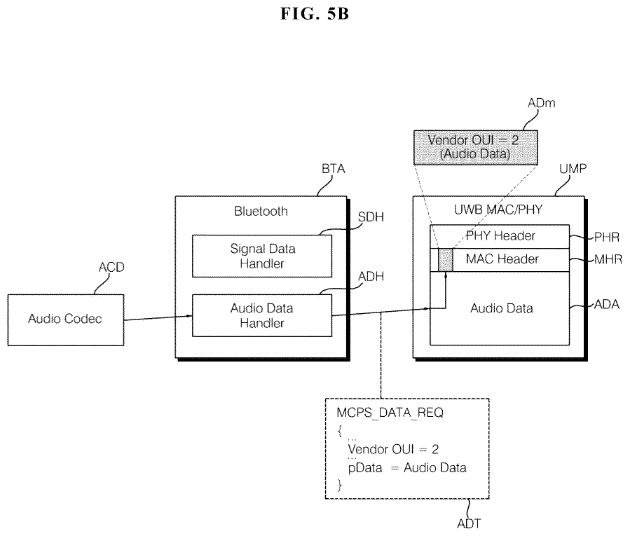

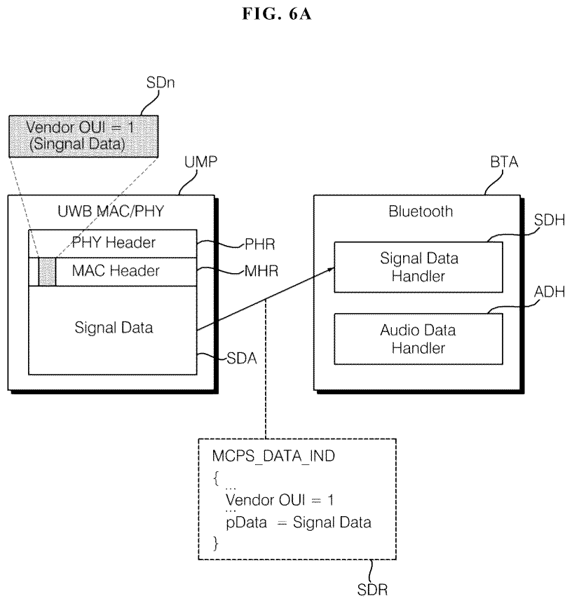

FIGS. 5A and 5B are diagrams for explaining an operation of a wireless audio transmitting device.

Referring to the drawing, the signal data handler SDH in the Bluetooth audio BTA of the wireless audio transmitting device 50 may define an identifier for distinguishing between signal data and audio data by using the Vendor OUI Field of the UWB MAC Header.

FIG. 5A illustrates signal data SDT when the Vendor OUI is ‘1’, and FIG. 5B illustrates audio data ADT when the Vendor OUI is ‘2’.

In particular, the Bluetooth audio BTA of the wireless audio transmitting device 50 may be configured to transmit signal data SDT for codec and QoS configuration used in the UWB audio service.

Meanwhile, when the wireless audio transmitting device 50 transmits the signal data SDT to the Media access control or physical layer (MAC/PHY) (UMP) of UWB, Vendor OUI, which is UWB MAC Header, may be set to ‘l’ and transmitted.

Meanwhile, in the wireless audio receiving device 100, when codec and QoS configuration are completed, audio data may be transmitted from the audio codec to Bluetooth audio BTA, and Bluetooth Audio BTA may be transmitted to the Media access control or physical layer (MAC/PHY) (UMP) of UWB by setting the Vendor OUI, which is UWB MAC Header, to ‘2’.

In addition, the wireless audio transmitting device 50 may be configured to transmit audio data to the wireless audio receiving device 100 with respect to Media access control or physical layer (MAC/PHY) (UMP) of UWB. Accordingly, even though the wireless environment is complicated, it is possible to stably receive audio wirelessly and output sound.

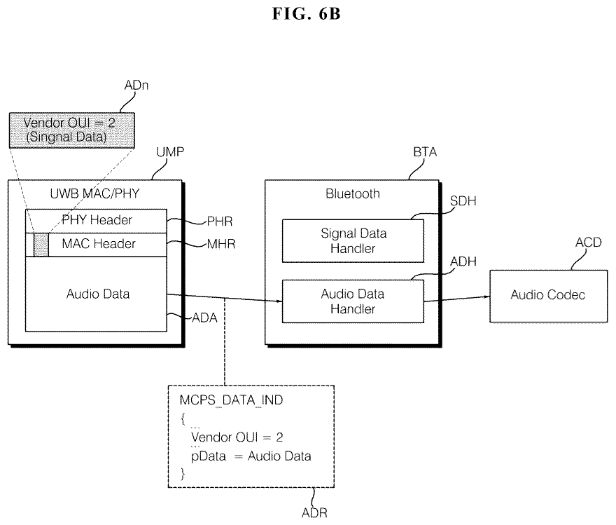

FIGS. 6A and 6B are diagrams for explaining an operation of a wireless audio receiving device.

Referring to the drawing, an identifier for distinguishing between signal data and audio data of Bluetooth audio (BTA) may be defined through the MCPS interface of the wireless audio receiving device 100.

FIG. 6A illustrates signal data SDR when the Vendor OUI is ‘1’, and FIG. 6B illustrates audio data ADR when the Vendor OUI is ‘2’.

When the Media access control or physical layer (MAC/PHY) (UMP) of UWB of the wireless audio receiving device 100 receives data having Vendor OUI, which is the UWB MAC Header, that is set to ‘1’, Bluetooth audio BTA may move to the signal data handler SDH.

In particular, the Bluetooth audio BTA of the wireless audio receiving device 100 may be configured to receive codec and QoS information used in the UWB audio service through a signal data handler SDH, and set information necessary for audio data reception.

Meanwhile, when the codec and QoS configuration for UWB audio service are completed, data whose Vendor OUI, which is the UWB MAC Header, is ‘2’ is received, and Bluetooth audio BTA may move to the audio data handler ADH.

The Bluetooth audio BTA sets a reproducing time for audio data received through an audio data handler (ADH), and the audio data having set reproducing time is transmitted to an audio codec. Accordingly, even though the wireless environment is complicated, it is possible to stably receive audio wirelessly and output sound.

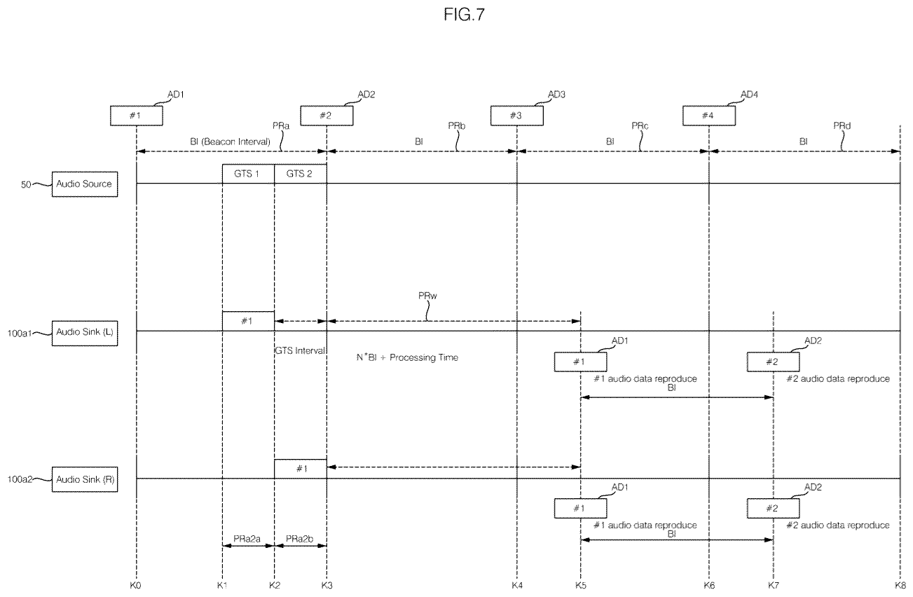

FIG. 7 is a diagram for explaining an UWB audio reproducing time synchronization.

Referring to FIG. 7, the wireless audio transmitting device 50 may sequentially transmit first to fourth audio data AD1 to AD4 to a plurality of wireless audio receiving devices 100a1 and 100a2 respectively.

In particular, the wireless audio transmitting device 50 may sequentially transmit the first to fourth audio data AD1 to AD4 for each channel in a beacon interval.

FIG. 7 illustrates that a first audio data AD1 is generated at time K0, transmitted to a first wireless audio receiving device 100a1 in an interval PRa2a between time K1 and time K2, and transmitted to a second wireless audio receiving device 100a2 in an interval PRa2b between time K2 and time K3.

Meanwhile, the interval PRa2a and the interval PRa2b may be set respectively by a plurality of wireless audio receiving devices 100a1 and 100a2 that receive audio data.

Similarly, at time K3, a second audio data AD2 is generated, and transmitted to the first wireless audio receiving device 100a1 and the second wireless audio receiving device 100a2, within a second beacon interval PRb.

Similarly, at time K4, a third audio data AD3 is generated, and transmitted to the first wireless audio receiving device 100a1 and the second wireless audio receiving device 100a2, within a third beacon interval PRc.

Similarly, at time K6, a fourth audio data AD4 is generated, and transmitted to the first wireless audio receiving device 100a1 and the second wireless audio receiving device 100a2, within a fourth beacon interval PRd.

Meanwhile, in order to synchronize and reproduce the first audio data AD1 received in a first beacon interval PRa in the plurality of wireless audio receiving devices 100a1 and 100a2, it is preferable that it is not reproduced in a second beacon interval PRb, but reproduced at the time K5 in the third beacon interval PRc.

That is, after audio data is reproduced, it is preferable that it is reproduced not in the next beacon interval but in the beacon interval after next.

Meanwhile, it is preferable that the interval PRw from the audio data reception completion time K3 to the reproducing start point K5 is greater than the length of the beacon interval. Accordingly, it is possible to stably synchronize and reproduce audio data.

Meanwhile, after the first audio data AD1 is reproduced at the time K5, it is preferable that the second audio data AD2 is spaced apart by the beacon interval and reproduced at the time K7. Accordingly, it is possible to stably synchronize and reproduce audio data.

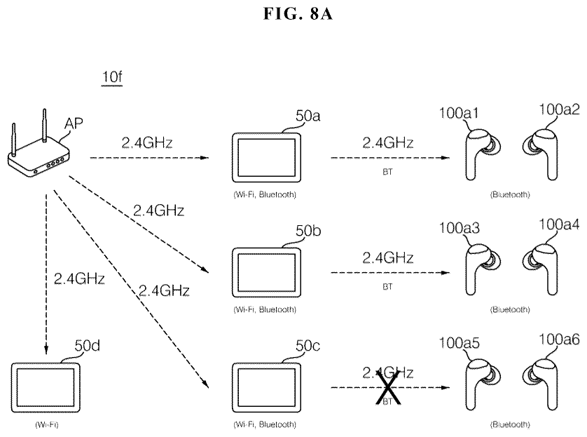

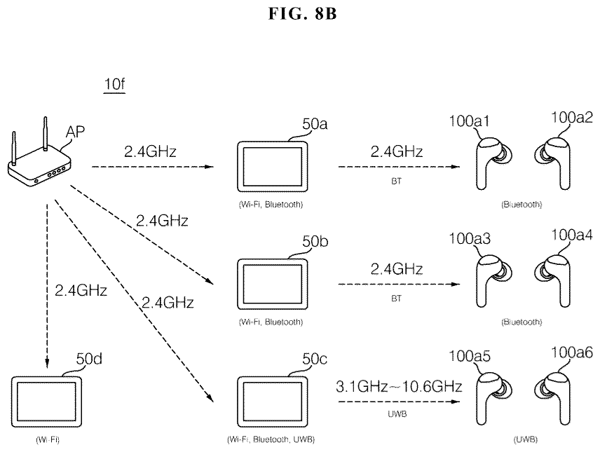

FIGS. 8A and 8B illustrate a wireless audio output system 10f including an AP device (AP), a plurality of wireless audio transmitting devices 50a to 50d, and a plurality of wireless audio receiving devices 100a1 to 100a6.

As shown in FIG. 8A, in a complicated wireless environment, between the plurality of wireless audio transmitting devices 50a to 50d and the plurality of wireless audio receiving devices 100a1 to 100a6, when audio is transmitted wirelessly by using Bluetooth communication which is the same first communication standard, audio data transmission becomes impossible due to frequency interference.

FIG. 8A illustrates that audio data transmission is impossible due to frequency interference, between a third wireless audio transmitting device 50c and the plurality of wireless audio receiving devices 100a5 to 100a6.

In order to solve this problem, an embodiment of the present disclosure utilizes the second communication standard having a larger frequency band and a larger bandwidth than the first communication standard. The second communication standard may be UWB.

As shown in FIG. 8B, in a complicated wireless environment, it is preferable that among a plurality of wireless audio transmitting devices 50a to 50d and a plurality of wireless audio receiving devices 100a1 to 100a6, devices excluding the third wireless audio transmitting device 50c and the plurality of wireless audio receiving devices 100a5 to 100a6 use Bluetooth communication which is the first communication standard, and the third wireless audio transmitting device 50c and the plurality of wireless audio receiving devices 100a5 to 100a6 use UWB communication. Accordingly, it is possible to stably transmit and receive wireless audio data even in a complicated wireless environment.

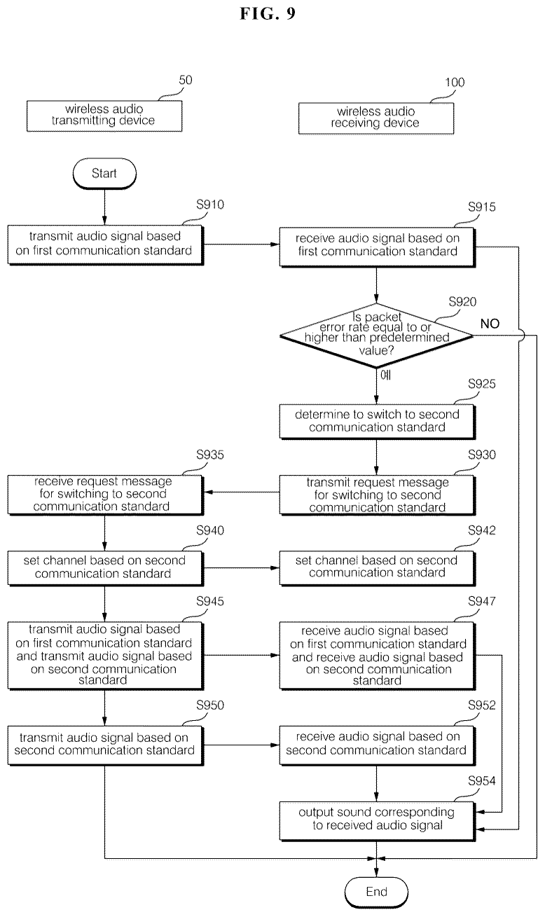

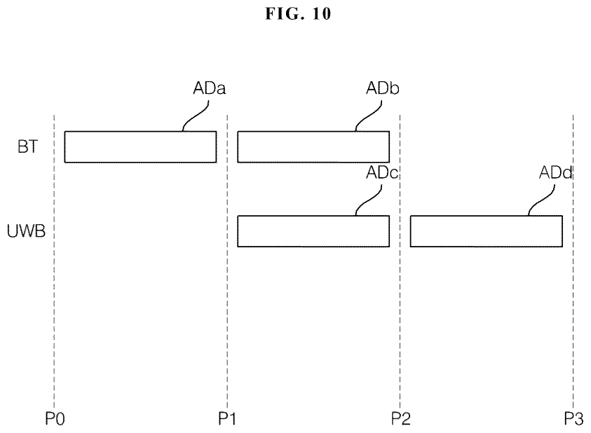

FIG. 9 is an example of a flowchart showing a method of operating a wireless audio output system according to an embodiment of the present disclosure.

Referring to FIG. 9, the wireless audio transmitting device 50 wirelessly transmits the first audio signal according to the first communication standard of the first frequency band in step S910.

In response, the first communication module 135a in the wireless audio receiving device 100 wirelessly receives the first audio signal according to the first communication standard of the first frequency band.

The processor 135c or 170 processes the first audio signal received through the first communication module 135a, and the sound output device 160 outputs a first sound based on the first audio signal during a first period P0-P1.

Meanwhile, the first communication module 135a or the processor 135c or 170 in the wireless audio receiving device 100 calculates the packet error rate of the audio signal received through the first communication module 135a.

The first communication module 135a or the processor 135c or 170 in the wireless audio receiving device 100 determines whether the packet error rate is equal to or higher than a predetermined value in step S920. If so, the first communication module or the processor determines to switch to the second communication standard, in step S925.

Accordingly, the first communication module 135a in the wireless audio receiving device 100 transmits a request message for switching to the second communication standard, in step S930.

In response, the wireless audio transmitting device 50 receives the switching request message in step S935, and performs channel setting according to the second communication standard in step S940.

In response, the first communication module 135a in the wireless audio receiving device 100 also performs channel setting according to the second communication standard in step S942.

Meanwhile, the second communication module 135b may be configured to perform channel setting based on a preset channel in response to setting the channel based on the second communication standard. Accordingly, it is possible to rapidly set the channel.

Meanwhile, in response to the channel setting being completed, the second communication module 135b may be configured to transmit a channel setup completion message to the wireless audio transmitting device 50. Accordingly, it is possible to rapidly perform a procedure after the channel has been set.

Next, during a second period, the wireless audio transmitting device 50 may be configured to transmit an audio signal based on the first communication standard, and may be configured to transmit an audio signal based on the second communication standard, in step S945.

In response, during the second period P1-P2, the first communication module 135a in the wireless audio receiving device 100 may be configured to receive the audio signal based on the first communication standard, and the second communication module 135b may be configured to receive the audio signal based on the second communication standard, in step S947.

The sound output device 160 may be configured to output the second sound based on the audio signal received from the first communication module 135a or the audio signal received from the second communication module 135b during the second period P1-P2. Accordingly, it is possible to seamlessly switch the audio service.

Meanwhile, during the second period P1-P2, the encoding method of the audio signal received from the first communication module 135a and the encoding method of the audio signal received from the second communication module 135b may be the same. Accordingly, it is possible to rapidly switch audio service.

Meanwhile, during the second period P1-P2, the received first audio signal and second audio signal each may include a sequence number.

For example, the processor 135c or 170 according to an embodiment of the present disclosure may determine time when the audio service switching is completed, based on the sequence number in the audio signal received from the first communication module 135a and the sequence number in the audio signal received from the second communication module 135b during the second period P1-P2, control to output sound based on the audio signal received from the first communication module 135a until the audio service switching is completed during the second period P1-P2, and control to output sound based on the audio signal received from the second communication module 135b from time when the audio service switching is completed during the second period P1-P2. Accordingly, it is possible to seamlessly switch the audio service.

Meanwhile, the second communication module 135b may be configured to transmit an audio service switching completion message to the wireless audio transmitting device 50 depending on the time of audio service switching completion.

Thus, the wireless audio transmitting device 50 stops receiving the audio signal according to the first communication standard, and transmits the audio signal according to the second communication standard during a third period P2-P3, in step S950.

In response, during the third period P2-P3, the second communication module 135b in the wireless audio receiving device 100 may be configured to receive the audio signal based on the second communication standard, in step S952.

Further, the sound output device 160 may be configured to output the second sound based on the audio signal received from the second communication module 135b during the third period P2-P3, in step S952. Accordingly, it is possible to seamlessly switch the audio service.

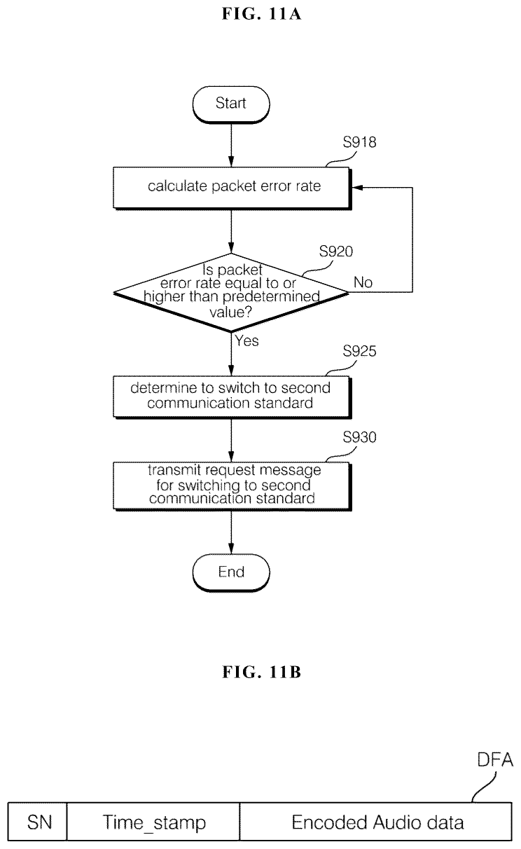

FIGS. 10 to 15B are diagrams for explaining FIG. 9.

First, FIG. 10 is a diagram illustrating the timing of Bluetooth communication, which is an example of the first communication standard, and UWB communication, which is the second communication standard.

Referring to FIG. 10, the wireless audio transmitting device 50 transmits the audio signal based on the first communication standard during the first period P0-P1, transmits the audio signal based on the first communication standard and the audio signal based on the second communication standard during the second period P1-P2, and transmits the audio signal based on the second communication standard during the third period P2-P3.

In response, the wireless audio receiving device 100 receives the audio signal based on the first communication standard during the first period P0-P1, receives the audio signal based on the first communication standard and the audio signal based on the second communication standard during the second period P1-P2, and receives the audio signal based on the second communication standard during the third period P2-P3.

That is, the first communication module 135a in the wireless audio receiving device 100 may be configured to receive the audio signal from the wireless audio transmitting device 50 during the first period P0-P1 and the second period P1-P2, and the second communication module 135b may be configured to receive the audio signal from the wireless audio transmitting device 50 during the second period P1-P2 and the third period P2-P3. Accordingly, it is possible to seamlessly switch the audio service.

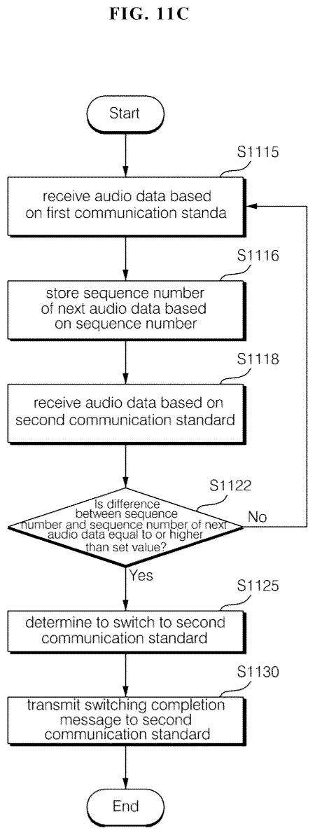

FIG. 11A is a flowchart illustrating an example of an operation method of the wireless audio receiving device of FIG. 9.

Referring to FIG. 11A, the first communication module 135a or the processor 135c or 170 in the wireless audio receiving device 100 calculates a packet error rate for the first audio signal wirelessly according to the first communication standard, in step S918.

When the calculated packet error rate is equal to or higher than a predetermined value, the first communication module 135a or processor 135c or 170 in the wireless audio receiving device 100 may determine to switch to the second communication standard, in step S925.

The first communication module 135a in the wireless audio receiving device 100 may determine to switch the audio service to the second communication standard, and transmit the switching request message to the wireless audio transmitting device 50, in step S930. Accordingly, it is possible to seamlessly switch the audio service through the first communication module 135a and the second communication module 135b of different communication standards. Furthermore, it is possible to stably receive audio wirelessly and output sound even in complex wireless environments.

FIG. 11B is a diagram illustrating an example of a data format of the audio signal of the first communication standard or the second communication standard.

Referring to FIG. 11B, the data format DFA of the audio signal of the first communication standard or the second communication standard may include a sequence number SN, a time stamp Time_stamp, and encoded audio data.

Meanwhile, the processor 135c or 170 according to an embodiment of the present disclosure may be configured to perform ordering based on the sequence number SN in the audio signal received from the first communication module 135a and the sequence number SN in the audio signal received from the second communication module 135b during the second period P1-P2, and may determine time when the audio service has been switched, based on the ordering.

Thus, the sound output device 160 may be configured to output sound based on the audio signal received from the first communication module 135a until the completion of the audio service switching during the second period P1-P2, and may be configured to output sound based on the audio signal received from the second communication module 135b, from time when the audio service switching is completed during the second period P1-P2. Accordingly, it is possible to seamlessly switch the audio service.

FIG. 11C is a flowchart illustrating another example of an operation method of the wireless audio receiving device of FIG. 9.

Referring to FIG. 11C, the first communication module 135a in the wireless audio receiving device 100 receives the first audio signal wirelessly according to the first communication standard, in step S1115.

The first communication module 135a or the processor 135c or 170 in the wireless audio receiving device 100 may control to store the sequence number of a next first audio signal based on the sequence number SN in the received first audio signal, in step S1116.

Next, during the second period P1-P2, the second communication module 135b in the wireless audio receiving device 100 receives the second audio signal wirelessly according to the second communication standard, in step S1119.

The second communication module 135b or the processor 135c or 170 in the wireless audio receiving device 100 may determine whether a difference between the sequence number SN in the received second audio signal and the sequence number of the next audio signal is equal to or higher than a set value in step S1122. If so, the second communication module or the processor may be configured to determine the completion time of switching to the second communication standard in step S1125.

For example, the processor 135c or 170 according to an embodiment of the present disclosure may compare the sequence number SN in the audio signal received from the first communication module 135a with the sequence number SN in the audio signal received from the second communication module 135b during the second period P1-P2, and may determine time when the audio service has been switched based on the compared results.

Thus, the sound output device 160 may be configured to output sound based on the audio signal received from the first communication module 135a until the completion of the audio service switching during the second period P1-P2, and output sound based on the audio signal received from the second communication module 135b, from time when the audio service switching is completed during the second period P1-P2. Accordingly, it is possible to seamlessly switch the audio service.

Meanwhile, the second communication module 135b in the wireless audio receiving device 100 may be configured to transmit the switching completion message to the wireless audio transmitting device 50 in step S1130.

Thus, the wireless audio transmitting device 50 may be configured to stop receiving the audio signal according to the first communication standard, and transmit the audio signal according to the second communication standard during the third period P2-P3.

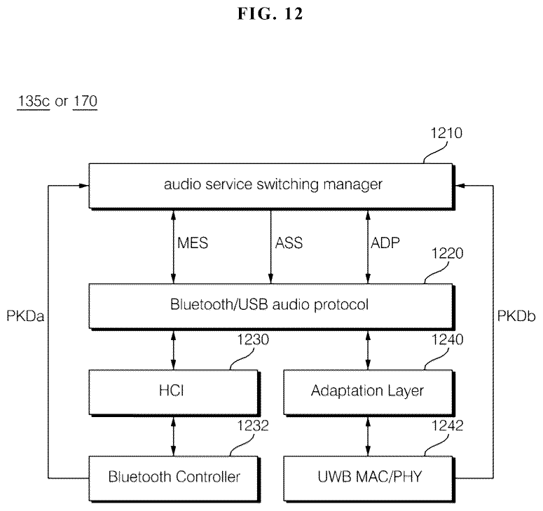

FIG. 12 is a diagram illustrating an audio service switching operation in the processor 135c or 170.

Referring to FIG. 12, the signal processing device 135c in the transceiver 135 or a separate processor 170 may include an audio service switching manager 1210, an audio protocol manager 1230 of the first communication standard and the second communication standard, a first communication standard interface 1230, a first communication standard controller 1232, an adaptation layer setting device 1240, and a second communication standard interface 1242.

The audio service switching manager 1210 may check a link status between the wireless audio transmitting device 50, which is an audio source, and the wireless audio receiving device 100, which is an audio sink, and may determine audio service switching based on the link status.

For example, the audio service switching manager 1210 may determine switching to the second communication standard when the packet error rate of the first audio signal received from the first communication module 135a is equal to or higher than a predetermined value.

As another example, the audio service switching manager 1210 may determine switching to the first communication standard when the packet error rate of the second audio signal received from the second communication module 135b is equal to or higher than a second predetermined value.

Meanwhile, the audio service switching manager 1210 may control to transmit the switching request message to the wireless audio transmitting device 50 when determining to switch the audio service.

Further, the audio service switching manager 1210 may set a system for switching the audio service, and may be configured to perform processing for audio channel setting.

For example, the audio service switching manager 1210 may set a system for switching to the second communication standard, and perform processing for audio channel setting according to the second communication standard.

Meanwhile, the audio service switching manager 1210 may process audio data for providing seamless audio service when switching the audio service.

For example, the audio service switching manager 1210 may compare the sequence number SN in the audio signal received from the first communication module 135a with the sequence number SN in the audio signal received from the second communication module 135b during the second period P1-P2, and may determine time when the audio service has been switched based on the compared results.

The audio protocol manager 1230 may be configured to transmit a switching request message generated by the audio service switching manager 1210 to the first communication standard interface 1230 or the adaptation layer setting device 1240.

The audio protocol manager 1230 may be configured to receive system setting for the audio service switching from the audio service switching manager 1210, and transmit the system setting for the audio service switching to the first communication standard interface 1230 or the adaptation layer setting device 1240.

The audio protocol manager 1230 may be configured to transmit audio data received from the first communication standard interface 1230 or the adaptation layer setting device 1240 to the audio service switching manager 1210.

The first communication standard interface 1230 may be a HCI (Host Control Interface).

The first communication standard controller 1232 may be configured to calculate the packet error rate of the audio signal of the received first communication standard, and transmit the calculated packet error rate PKDa to the audio service switching manager 1210.

The adaptation layer setting device 1240 may map data of the first communication standard to data of the second communication standard using the adaptation layer AL. Accordingly, signal data and audio data can be distinguished, thereby stably transmitting audio wirelessly.

The second communication standard interface 1242 may be configured to calculate the packet error rate of the audio signal of the received first communication standard, and transmit the calculated packet error rate PKDb to the audio service switching manager 1210.

Meanwhile, the second communication standard interface 1242 may be configured to perform a PHY (Physical layer) or a MAC (Media Access Control).

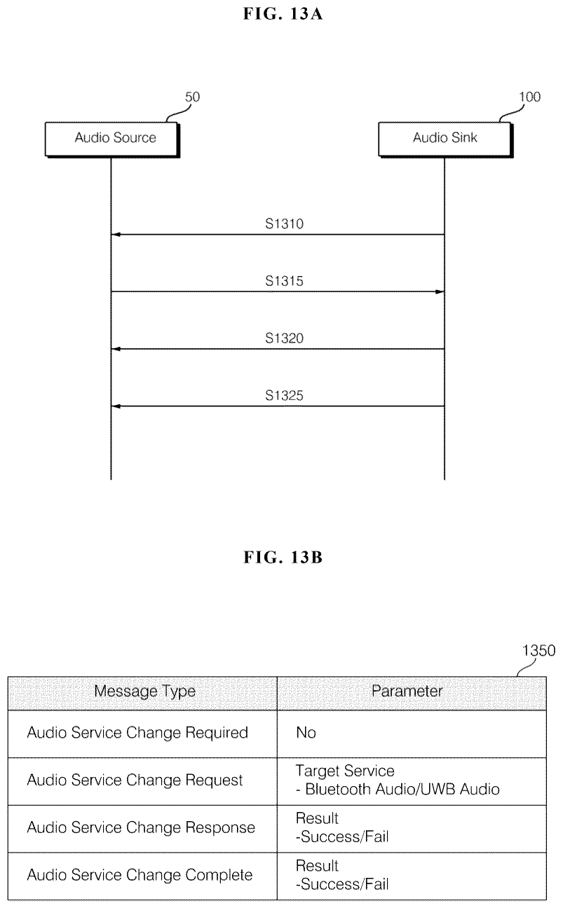

FIGS. 13A and 13B are diagrams for explaining message transmission between the wireless audio receiving device 100 and the wireless audio transmitting device 50.

FIG. 13A is a flowchart for explaining message transmission between the wireless audio receiving device 100 and the wireless audio transmitting device 50, and FIG. 13B is a diagram for explaining a message type between the wireless audio receiving device 100 and the wireless audio transmitting device 50.

Referring to the drawing, the wireless audio receiving device 100, which is the audio sink, transmits an audio service switching request message in step S1310.

For example, when the packet error rate of the first audio signal of the first communication standard is equal to or higher than a predetermined value, a message requesting switch to the second communication standard may be transmitted.

In response, the wireless audio transmitting device 50, which is the audio source, receives the audio service switching request message.

The wireless audio transmitting device 50 transmits a target service message related to the audio service switching request, in step S1315.

In response, the wireless audio receiving device 100 receives the target service message related to the audio service switching request.

The target service message related to the audio service switching request may include Bluetooth audio service information or UWB audio service information, as shown in FIG. 13B.

Next, the wireless audio receiving device 100 transmits an audio service switching response message, in step S1320. In response, the wireless audio transmitting device 50 receives an audio service switching response.

At this time, the audio service switching response message may include success information or fail information.

Next, the wireless audio receiving device 100 transmits an audio service switching completion message when the audio service switching is completed, in step S1325. In response, the wireless audio transmitting device 50 receives the audio service switching completion message.

At this time, the audio service switching completion message may include success information or fail information.

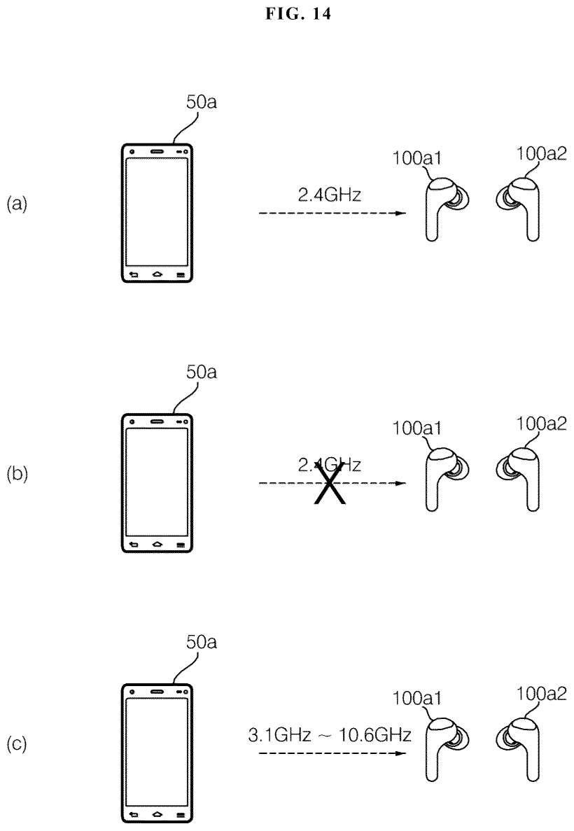

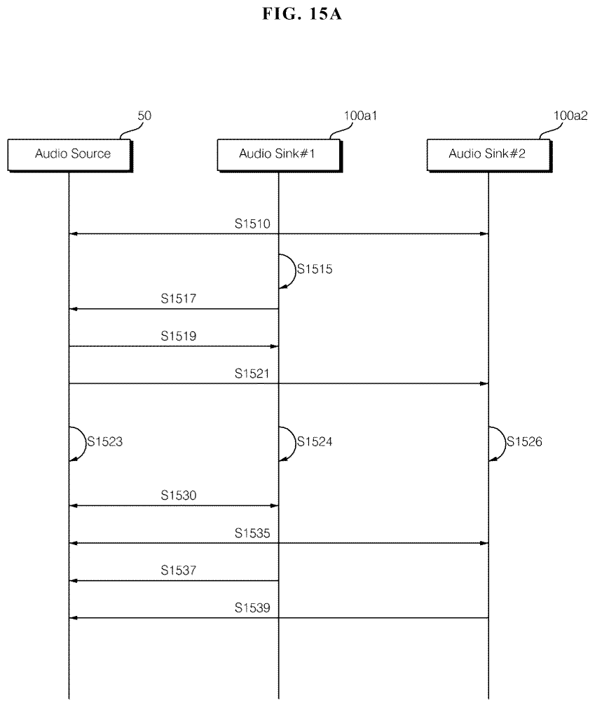

FIG. 14 is a diagram for explaining the audio service according to the first communication standard or the second communication standard.

FIG. 14(a) illustrates that during the first period P0-P1, the audio transmitting device 50a transmits the first audio signal of the first communication standard to a plurality of wireless audio receiving devices 100a1 and 100a2.

When the packet error rate of the first audio signal is less than a predetermined value, sound is output without quality degradation from the plurality of wireless audio receiving devices 100a1 and 100a2.

FIG. 14(b) illustrates that during the first period P0-P1, the audio transmitting device 50a transmits the first audio signal of the first communication standard to the plurality of wireless audio receiving devices 100a1 and 100a2, but the transmission is not smooth.

For example, when the packet error rate of the first audio signal is equal to or higher than a predetermined value because the wireless environments is complicated, sound of poor quality may be output from the plurality of wireless audio receiving devices 100a1 and 100a2.

In order to solve this problem, the present disclosure performs audio service switching to the second communication standard. In particular, for seamless audio service switching during the audio service switching, a section for simultaneously outputting the audio signal of the first communication standard and the audio signal of the second communication standard is utilized as described in FIGS. 9 to 13B.

Meanwhile, after the audio service switching is completed, the transmission of the audio signal of the first communication standard is completed.

FIG. 14(c) illustrates that during the third period P2-P3, the audio transmitting device 50a transmits the second audio signal of the second communication standard to the plurality of wireless audio receiving devices 100a1 and 100a2.

As the audio service switching is completed, the transmission of the audio signal of the first communication standard is completed. The plurality of wireless audio receiving devices 100a1 and 100a2 output sound without quality degradation, based on the second audio signal of the received second communication standard.

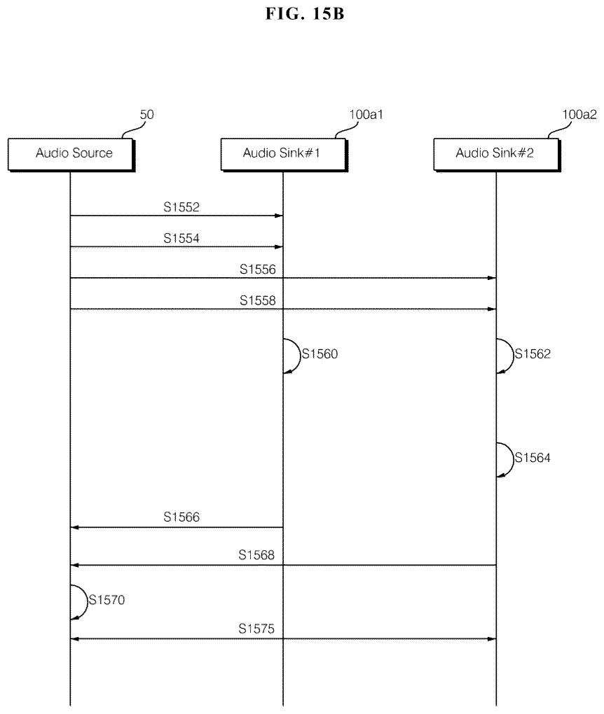

FIG. 15A is an example of a flowchart showing an operation method between the audio transmitting device 50a and the plurality of wireless audio receiving devices 100a1 and 100a2.

Referring to FIG. 15A, the wireless audio transmitting device 50 transmits the first audio signal wirelessly according to the first communication standard of the first frequency band, in step S1510.

In response, the first communication module 135a in the first wireless audio receiving device 100a1 and the second wireless audio receiving device 100a2 wirelessly receives the first audio signal according to the first communication standard of the first frequency band, and the sound output device 160 outputs the first sound based on the first audio signal during the first period P0-P1.

Meanwhile, the first communication module 135a or the processor 135c or 170 in the first wireless audio receiving device 100a1 calculates the packet error rate of the audio signal received through the first communication module 135a.

The first communication module 135a or the processor 135c or 170 in the first wireless audio receiving device 100a1 determines whether the packet error rate is equal to or higher than a predetermined value. If so, a decision is made to switch to the second communication standard, in step S1515.

Thus, the first communication module 135a in the first wireless audio receiving device 100a1 transmits the request message for switching to the second communication standard to the wireless audio transmitting device 50, in step S1517.

In response, the wireless audio transmitting device 50 receives the switching request message, and transmits the target service message related to the audio service switching request to the first wireless audio receiving device 100a1 and the second wireless audio receiving device 100a2, in steps S1519 and S1521.

For example, the target service message may include a message for switching to the second communication standard.

Next, each of the wireless audio transmitting device 50, the first wireless audio receiving device 100a1, and the second wireless audio receiving device 100a2 performs audio setting corresponding to the second communication standard, in steps S1523, S1524, and S1526.

The audio setting corresponding to the second communication standard may include audio encoding parameter setting or audio channel setting.

Next, the wireless audio transmitting device 50 performs channel connection corresponding to the second communication standard with each of the first wireless audio receiving device 100a1 and the second wireless audio receiving device 100a2, in steps S1530 and S1535.

At this time, in order to shorten time required for channel connection according to the second communication standard, the beacon of the second communication standard may be transmitted and received based on a preset channel and preamble.

Meanwhile, when the channel connection corresponding to the second communication standard is completed, the first wireless audio receiving device 100a1 and the second wireless audio receiving device 100a2 each may be configured to transmit a channel connection completion message to the wireless audio transmitting device 50, in steps S1537 and S1539. Thus, the channel connection corresponding to the second communication standard is completed.

FIG. 15B is another example of a flowchart showing an operation method between the audio transmitting device 50a and the plurality of wireless audio receiving devices 100a1 and 100a2.

Referring to FIG. 15B, during the second period P1-P2, the wireless audio transmitting device 50 transmits the audio signal based on the first communication standard to each of the first wireless audio receiving device 100a1 and the second wireless audio receiving device 100a2 in steps S1552 and S1556, and transmits the audio signal based on the second communication standard to each of the first wireless audio receiving device 100a1 and the second wireless audio receiving device 100a2 in steps S1554 and S1558.

The first wireless audio receiving device 100a1 performs an ordering process based on the sequence number in the audio signal based on the first communication standard received and the sequence number in the audio signal based on the second communication standard, in step S1560.

Meanwhile, the second wireless audio receiving device 100a2 performs an ordering process based on the sequence number in the audio signal based on the first communication standard received and the sequence number in the audio signal based on the second communication standard, in step S1562

The first wireless audio receiving device 100a1 and the second wireless audio receiving device 100a2 each may determine the service switching completion time based on the ordering process.

The drawing illustrates an example where the second wireless audio receiving device 100a2 determines time when the service switching is completed, in step S1564.

Alternatively, the first wireless audio receiving device 100a1 and the second wireless audio receiving device 100a2 each may determine the service switching completion time, share the two service switching completion times with each other, and then determine one of the times as final service switching completion time.

After the service switching completion time, the first wireless audio receiving device 100a1 and the second wireless audio receiving device 100a2 each may be configured to transmit the service switching completion message to the wireless audio transmitting device 50, in steps S1566 and S1568.

Thus, the wireless audio transmitting device 50 performs audio service switching from the first communication standard to the second communication standard, in step S1570.

Further, the wireless audio transmitting device 50 terminates connection between the first wireless audio receiving device 100a1 and the second wireless audio receiving device 100a2, according to the first communication standard, in step S1575.

Subsequently, during the third period P2-P3, the wireless audio transmitting device 50 transmits the audio signal based on the second communication standard to the first wireless audio receiving device 100a1 and the second wireless audio receiving device 100a2.

In response, the first wireless audio receiving device 100a1 and the second wireless audio receiving device 100a2 may be configured to receive the audio signal based on the second communication standard, and may be configured to output the second sound, based on the audio signal received from the second communication module 135b. Accordingly, it is possible to seamlessly switch the audio service.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

1. A wireless audio receiving device comprising:
a first communication module configured to wirelessly receive a first audio signal based on a first communication standard of a first frequency band:
a second communication module configured to wirelessly receive a second audio signal based on a second communication standard of a second frequency band greater than the first frequency band; and
a sound output device configured to output a first sound corresponding to the first audio signal from the first communication module or a second sound corresponding to the second audio signal from the second communication module,
wherein the first communication module is configured to receive a first audio signal comprising a first sequence number during a first period.
wherein the second communication module is configured to receive a second audio signal comprising a second sequence number based on an ultra-wideband (UWB) communication standard during a second period after the first period,
wherein the sound output device is configured to output a first sound, based on the first audio signal received from the first communication module, during the first period, and output a second sound, based on the first audio signal received from the first communication module or the second audio signal received from the second communication module, during the second period, in response to a packet error rate of the first audio signal being equal to or higher than a predetermined value, and output a third sound, based on the second audio signal received from the second communication module, during a third period after the second period.

2. The wireless audio receiving device of claim 1, wherein the first communication module is configured to transmit a message switching to the second communication standard to a wireless audio transmitting device, in response to the packet error rate of the first audio signal received from the first communication module being equal to or higher than the predetermined value.

3. The wireless audio receiving device of claim 1,
wherein the first communication module is configured to transmit a message switching to the second communication standard to a wireless audio transmitting device, in response to the packet error rate of the first audio signal received from the first communication module being equal to or higher than the predetermined value,
wherein the second communication module is configured to set a channel based on the second communication standard, after transmitting the message switching to the second communication standard, and
wherein the sound output device is configured to output the second sound, based on the first audio signal received from the first communication module or the second audio signal received from the second communication module, during the second period.

4. The wireless audio receiving device of claim 3, wherein the second communication module is configured to perform channel setting based on a preset channel, in response to setting the channel based on the second communication standard.

5. The wireless audio receiving device of claim 3, wherein the second communication module is configured to transmit a channel setup completion message to the wireless audio transmitting device in response to the channel setting being completed.

6. The wireless audio receiving device of claim 1, wherein, during the second period, an encoding method of the first audio signal received from the first communication module and an encoding method of the second audio signal received from the second communication module are the same.

7. (canceled)

8. The wireless audio receiving device of claim 1, further comprising:
a processor configured to process a signal from the first communication module or the second communication module,
wherein the processor is configured to determine audio service switching completion time, based on the first sequence number in the first audio signal received from the first communication module and the second sequence number in the audio signal received from the second communication module, during the second period, output a sound based on the first audio signal received from the first communication module, until the audio service switching completion time during the second period, and output a sound based on the second audio signal received from the second communication module, from the audio service switching completion time.

9. The wireless audio receiving device of claim 8, wherein the second communication module is configured to transmit an audio service switching completion message to the wireless audio transmitting device, based on the audio service switching completion time.

10. The wireless audio receiving device of claim 1,
wherein the first communication module is configured to receive the first audio signal from the wireless audio transmitting device, during the first period and the second period, and
wherein the second communication module is configured to receive the second audio signal from the wireless audio transmitting device, during the second period and the third period.

11. A wireless audio receiving device comprising:
a first communication module configured to wirelessly receive a first audio signal based on a first communication standard of a first frequency band:
a second communication module configured to wirelessly receive a second audio signal based on a second communication standard of a second frequency band greater than the first frequency band: and
a sound output device configured to output a first sound corresponding to the first audio signal from the first communication module or a second sound corresponding to the second audio signal from the second communication module,
wherein the second communication module is configured to transmit a message switching to the second communication standard to a wireless audio transmitting device, in response to a packet error rate of the first audio signal received from the first communication module being equal to or higher than a predetermined value,
wherein the first communication module is configured to receive a first audio signal comprising a first sequence number during a first period,
wherein the second communication module is configured to receive a second audio signal comprising a second sequence number based on an ultra-wideband (UWB) communication standard during a second period after the first period.

12. The wireless audio receiving device of claim 11, wherein the sound output device is configured to output a first sound corresponding to the first audio signal from the first communication module, in response to the packet error rate of the first audio signal received from the first communication module being less than the predetermined value, and output a sound corresponding to the audio signal received from the first communication module or the second communication module, in response to the packet error rate of the first audio signal received from the first communication module being equal to or higher than the predetermined value, and output a second sound corresponding to the second audio signal from the second communication module, after the audio service switching is completed.

13. A wireless audio transmitting device comprising:
a first communication module configured to wirelessly transmit a first audio signal based on a first communication standard of a first frequency band:
a second communication module configured to wirelessly transmit a second audio signal based on a second communication standard of a second frequency band greater than the first frequency band; and
a processor configured to control the first communication module and the second communication module,
wherein the processor is configured to control the first communication module to transmit the first audio signal during a first period, and control the first communication module and the second communication module to transmit the audio signal, during a second period after the first period, in response to receiving a switching message from the wireless audio receiving device,
wherein the first communication module is configured to receive a first audio signal comprising a first sequence number during a first period,
wherein the second communication module is configured to receive a second audio signal comprising a second sequence number based on an ultra-wideband (UWB) communication standard during a second period after the first period.

14. The wireless audio transmitting device of claim 13, wherein the processor is configured to control the second communication module to transmit the audio signal during a third period after the second period, in response to receiving an audio service switching completion message from the wireless audio receiving device.

15. A wireless audio output system, comprising:
a wireless audio transmitting device; and
a wireless audio receiving device,
wherein the wireless audio receiving device comprises:
a first communication module configured to wirelessly receive a first audio signal based on a first communication standard of a first frequency band;
a second communication module configured to wirelessly receive a second audio signal based on a second communication standard of a second frequency band greater than the first frequency band; and
a sound output device configured to output a first sound corresponding to the first audio signal from the first communication module or a second sound corresponding to the second audio signal from the second communication module.
wherein the first communication module is configured to receive a first audio signal comprising a first sequence number during a first period,
wherein the second communication module is configured to receive a second audio signal comprising a second sequence number based on an ultra-wideband (UWB) communication standard during a second period after the first period.
wherein the sound output device is configured to output a first sound, based on the first audio signal received from the first communication module, during the first period, and output a second sound, based on the first audio signal received from the first communication module or the second audio signal received from the second communication module, during the second period, in response to a packet error rate of the first audio signal being equal to or higher than a predetermined value, and output a third sound, based on the second audio signal received from the second communication module, during a third period after the second period.

16. The wireless audio output system of claim 15, wherein the wireless audio transmitting device comprises:
a third communication module configured to wirelessly transmit a first audio signal based on a first communication standard of a first frequency band:
a fourth communication module configured to wirelessly transmit a second audio signal based on a second communication standard of a second frequency band greater than the first frequency band: and
a second processor configured to control the third communication module and the fourth communication module,
wherein the second processor is configured to control the third communication module to transmit the first audio signal during a first period, and control the third communication module and the fourth communication module to transmit the audio signal, during a second period after the first period, in response to receiving a switching message from the wireless audio receiving device,
wherein the third communication module is configured to receive a first audio signal comprising a first sequence number during a first period,
wherein the fourth communication module is configured to receive a second audio signal comprising a second sequence number based on an ultra-wideband (UWB) communication standard during a second period after the first period.
